(19) United States
(12) Patent Application Publication
(10) Pub. No.: US 2012/0199075 A1
(43) Pub. Date: Aug. 9, 2012

(54) MULTI-LAYER PET BED

(76) Inventor: Wonjung Song, Richmond, CA (US)

(21) Appl. No.: 13/021,495

(22) Filed: Feb. 4, 2011

(51) Int. Cl. A01K 1/035; A01K 29/00

(52) U.S. Cl. 119/28.5

(57) ABSTRACT

A pet bed having an outer fabric layer which defines its shape. The fabric layer encases at least two distinct regions. A first regions comprises a fiber filled bolster and the second region comprises memory foam.

### TECHNICAL FIELD

The present invention involves a bedding product which is ideally suited for use as a pet bed. Pet beds of this type are intended for use by dogs appreciative of a pet bed which provides differing surfaces facilitating lounging and sleeping while also providing a therapeutic foundation.

### BACKGROUND OF THE INVENTION

It is quite common to provide a pet bed particularly for a dog as an alternative to the dog sleeping and lounging on a hard or thinly carpeted surface. As dogs grow older, they tend to spend more time sleeping and lounging while, at the same time, oftentimes must cope with arthritic and similar debilitating conditions. Many pet owners are insensitive to a dog's needs for most dogs do not express their discomfort as they continue to silently suffer as they attempt to sleep and lounge.

It is thus an object of the present invention to provide a bedding product which provides two unique surface regions to accommodate a dog.

A further object of the present invention is to provide a bedding product suitable for pets of all ages and which is particularly suitable for older dogs and those suffering from arthritis.

These and further objects will be more readily apparent when considering the following disclosure and appended claims.

### SUMMARY OF THE INVENTION

A pet bed having an outer fabric layer which defines its shape. The fabric layer encases at least two distinct regions. A first regions comprises a fiber filled bolster and the second region comprises memory foam.

### BRIEF DESCRIPTION OF THE FIGURES

FIG. 1 is a perspective view of the pet bed of the present invention.

FIG. 2 is a cross sectional view of the present invention taken along line 2-2 of FIG. 1.

### DETAILED DESCRIPTION OF THE INVENTION

Novel features which are characteristic of the invention, as to organization and method of operation, together with further objects and advantages thereof will be better understood from the following description considered in connection with the accompanying drawings, in which preferred embodiments of the invention are illustrated by way of example. It is to be expressly understood, however, that the drawings are for illustration description only and are not intended as definitions of the limits of the invention. The various features of novelty which characterize the invention are recited with particularity in the claims.

There has been broadly outlined more important features of the invention in the summary above and in order that the detailed description which follows may be better understood, and in order that the present contribution to the art may be appreciated. There are, of course, additional features of the invention that will be described hereinafter and which will form additional subject matter of the claims appended hereto. Those skilled in the art will appreciate that the conception upon which this disclosure is based readily may be utilized as a basis for the designing of other structures, methods and systems for carrying out the several purposes of the present invention. It is important therefore, that claims be regarded as including such equivalent constructions insofar as they do not depart from the spirit and scope of the present invention.

Certain terminology and the derivations thereof may be used in the following description for convenience and reference only, and will not be limiting. For example, words such as “upward,” “downward,” “left,” and “right” refer to directions in the drawings to which reference is made unless otherwise stated. Similar words such as “inward” and “outward” refer to directions toward and away from, respectively, the geometric center of a device or area and designated parts thereof. Reference in the singular tense include the plural and vice versa, unless otherwise noted.

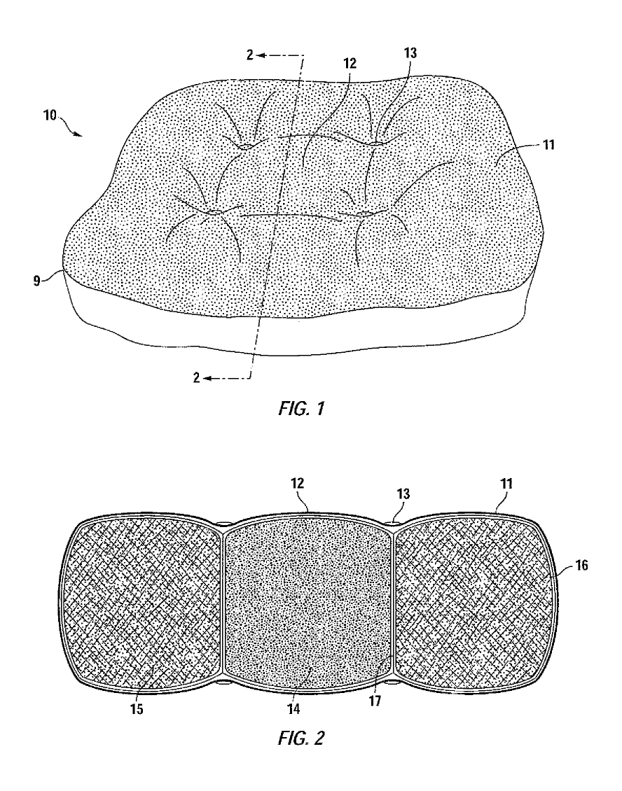

Turning to FIG. 1, pet bed 10 of the present invention is shown having outer fabric layer 9 defining its shape. Ideally, outer fabric layer 9 is plush providing a soft inviting surface to the pet.

Pet bed 10 is characterized as having two distinct regions, that it is, first region 11 and second region 12. Second region 12 is segregated from first region 11 and can be held in place by optional tufting buttons 13. As noted from reference to FIG. 2, first region is encased in liner 16 while second region is encased in liner 17 to facilitate the removal of both regions from outer fabric 9 to facilitate their cleaning and replacement.

First region 11 is composed of fiber 15, again, occupying a space defined by liner 16. As being environmentally responsible, fiber 15 can be composed of recycled soft drink bottles which are generally composed of polyethylene terephthalate. Alternatively, first region 11 could be composed of open cell foam. Second region 12 is composed either of chopped memory foam or a uniform block of memory foam 14 encased within liner 17. Liner 17 is particularly advantageous when chopped memory foam is employed to maintain the integrity of second region 12. First and second regions 11 and 12 are segregated from one another not only through the use of liners 16 and 17 but also by tufting the surface of pet bed 10 through the use of, for example, buttons 13.

It has been determined through testing and observation that first region 11 provides comfort to a pet dog while second region 12 is therapeutic. Younger dogs which do not have arthritic or achy joints may prefer to lounge mostly in first region 11 while second region 12 creates a therapeutic foundation for sleep. As a pet ages or as the present pet bed is introduced to a pet having arthritis or other painful conditions, the pet would tend to lounge most often in second region 12 as opposed to first region 11.

Although not shown, the pet bed of the present invention can also have a closeable seam in order to enable fiber fill or open cell foam 15 and memory foam 14 to be removed from outer fabric layer 9 for cleaning and replacement.

The above disclosure is sufficient to enable one of ordinary skill in the art to practice the invention, and provides the best mode of practicing the invention presently contemplated by the inventor. While there is provided herein a full and complete disclosure of the preferred embodiments of the invention, it is not desired to limit the invention to the exact construction, dimensions, relationships, or operations as described. Various modifications, alternative constructions, changes and equivalents will readily occur to those skilled in the art and may be employed as suitable without departing from the true spirit and scope of the invention. Such changes might involve alternative materials, components, structural arrangements, sizes, shapes, forms, functions, operational features or the like. Therefore, the above description and illustration should not be considered as limiting the scope of the invention, which is defined by the appended claims.

1. A pet bed comprising an outer fabric layer defining its shape, said fabric layer encasing at least two distinct regions, first region comprising a fiber filled bolster and the second region comprising memory foam.

2. The pet bed of claim 1 wherein said second region comprises chopped memory foam.

3. The pet bed of claim 1 wherein said second region comprises a uniform block of memory foam.

4. The pet bed of claim 1 wherein said first and second regions are housed in liners to facilitate their removal from said outer fabric.

5. The pet bed of claim 1 wherein said first region comprises recycled polyethylene terephthalate.

6. The pet bed of claim 1 wherein said at least two distinct regions are separated to provide different support areas below said outer fabric layer.

7. A pet bed comprising an outer fabric layer defining its shape, said fabric layer encasing at least two distinct regions, a first region comprising an open cell foam filled bolster and the second region comprising memory foam.
